(19) United States
(12) Patent Application Publication
(10) Pub. No.: US 2015/0105706 A1
(43) Pub. Date: Apr. 16, 2015

(54) METHOD FOR CALMING A PERSON

(71) Applicant: Reizel Polak, Brookline, MA (US)

(72) Inventor: Reizel Polak, Brookline, MA (US)

(21) Appl. No.: 14/051,272

(22) Filed: Oct. 10, 2013

(51) Int. Cl. A61H 9/00; A61H 1/00

(52) U.S. Cl. CPC A61H 9/005; A61H 1/008; A61H 2201/0103; A61H 2201/1409
USPC 601/151

(57) ABSTRACT

The present invention relates to a method for reducing stress or promoting relaxation in a person is disclosed herein. The method includes the use of a deflatable cushion which has an attachment for a vacuum pump and includes positioning the person in need upon the cushion so that the cushion extends at least the length of the person's torso, eliminating a sufficient amount of air from the cushion so that the cushion at least partially envelops the person, and keeping or retaining the person in the enveloping cushion for a sufficient time for reducing the stress or producing relaxation.

### FIELD OF THE INVENTION

The present invention generally relates to a method for calming a person. Specifically, the present invention discloses a therapeutic intervention for reducing stress (with or without emotional dysregulation) and promoting relaxation in a person. In particular, the present invention discloses a method for producing a calming effect upon a person, including an individual in a population of people having a range of dysregulated emotions and behaviors by using a calming cushion. Such use of the cushion can provide a calming effect upon the person.

### BACKGROUND OF THE INVENTION

Many techniques have been used to address dysregulated emotional behavior. Such techniques include behavior modification, self-management skills, systems of reward and punishment, seclusion and restraints, weighted vests and blankets and a variety of other therapies.

Typical therapies have, as a matter of policy, no physical contact, i.e. no normative contact, no hugs, no arms around a shoulder, no pat on the back. Only the following are typically permitted: high fives, first pound, elbow to elbow, and handshakes. However, all therapies have limited success with a population that requires emotional and behavioral containment. There is therefore a great need for a method which can address the negative emotional and behavioral issues with a successful outcome.

Accordingly, there is now provided with this invention an improved method for reducing emotional dysregulation in a person thereby effectively overcoming the aforementioned difficulties and longstanding problems in behavioral therapy.

### SUMMARY OF THE INVENTION

The claimed invention is at least in part based on an unexpected finding that a cushion capable of partially enveloping a person can be used to calm a person having stress or anxiety. The cushion provides a soothing, calming, secure sense of being held, as well as producing a relaxing feeling. In one aspect of the invention, a method for reducing emotional dysregulation in a person is disclosed herein. The method includes using a deflatable cushion which has an attachment for a vacuum pump and includes identifying a person having emotional dysregulation, where the emotionally dysregulated person lies upon the cushion that extends at least the length of the emotionally dysregulated person's torso, and in some embodiments, the full body length. The person is positioned by, e.g., placing the person directly upon or, preferably, allowing the person to place himself or herself on the cushion, then eliminating a sufficient amount of air from the cushion so that the cushion at least partially envelops the emotionally dysregulated person, and then keeping or retaining or allowing the emotionally dysregulated person to remain in the enveloped cushion for a sufficient time for reducing the person's emotional dysregulation, e.g., for fifteen minutes.

In another aspect of the invention, a method for reducing stress or promoting relaxation in a person in need thereof is disclosed. The method includes positioning a person in need upon a cushion having a nozzle attached to a vacuum pump, wherein the cushion extends at least the length of the person's torso, eliminating a sufficient amount of air from the cushion by turning on the vacuum pump to ensure that the cushion at least partially envelops the person, and keeping or retaining the person in the enveloped cushion for a sufficient time for reducing the stress or producing relaxation in the person.

In one embodiment, the methods described above further comprise holding the cushion's sides against the body of the person during the elimination step.

In another embodiment, the methods described above further comprise the following steps: detaching the vacuum pump from the attachment and retaining the vacuum in the cushion after the eliminating step.

In yet another embodiment, the methods described above further comprise the following steps after the keeping step: getting the person out of the enveloped cushion and retaining the cushion in the enveloped state for use at another time.

In still another aspect of the invention, a method for reducing stress or promoting relaxation in a person in need thereof includes positioning a person in need upon a cushion that is preformed to have a snug fit against the person, wherein the cushion extends at least the length of the person's torso, and keeping the person in the enveloped cushion for a sufficient time for reducing the stress or producing relaxation in the person.

In one embodiment, the methods described above further comprise speaking to the person when being enveloped in the cushion.

In another embodiment, the methods described above further comprise obtaining verbal feedback from the person regarding the fit of the cushion.

The envelopment of the person provides a safe and comfortable pressure against that person's body, as will be discussed herein.

Also within the scope of the invention, the method further comprises covering the person's chest and/or feet with a weighted blanket. Additionally or alternatively, the method further comprises a heat element, e.g., a heated blanket or a heated cushion.

The sufficient time referred to in the above-described methods can vary from person to person and session to session, preferably, 5 to 60 minutes; more preferably, 10 to 30 minutes; most preferably 15 minutes.

In the above described methods, stress is reduced in the person such that the frequency of time outs (e.g., time outs initiated by staff) required by the person is significantly reduced, stress is reduced in the person such that the frequency of restraints required for the person is significantly reduced; stress is reduced in the person such that the frequency of escorts required for the person is significantly reduced; or stress is reduced in the person such that the person can participate in normal daily activities without provocative or inappropriate behavior caused by stress.

As will be appreciated by those persons skilled in the art, a major advantage provided by the present invention is that a calming effect is produced upon a person who may be under stress (either with or without emotional dysregulation). Additional objects of the present invention will become apparent from the following description.

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

### BRIEF DESCRIPTION OF THE FIGURES

FIG. 1 shows a picture of Bionix T-Vac cushion as not been evacuated to envelop any person. The Bionix cushion is durable, accurate and cost-effective. It is reusable and airtight filled with small polystyrene spheres to immobilize the person to be treated. The cushion features a new nylon material that is stronger to prevent punctures and leaks. It is manufactured from thick nylon for a durable, rigid mold; includes dual check valve and hose clamp to reduce leaking; holds form for an entire treatment cycle (6-8 weeks); adaptable to industry standard pumps; locks down to a variety of tabletops; available in a variety of sizes & fills to meet treatment needs.

FIG. 2 shows a picture of Bionix SecureVac Cushion that has been evacuated to envelop a person in need of therapy.

### DETAILED DESCRIPTION OF THE INVENTION

The present invention is directed to methods for reducing stress or promoting relaxation in a person using a calming cushion.

The person in need of treatment with the methods of the present invention described herein includes: a person suffering from early childhood trauma, e.g. neglect, abuse, or abandonment; a person suffering from a traumatic brain injury or hydrocephalus; a person suffering from a cognitive disability (including a mild to severe cognitive retardation); or a person suffering from a mental disorder. Examples of the mental disorder include mental retardation, an anxiety disorder (e.g., a generalized anxiety disorder), a Mood disorder not otherwise specified, a pervasive developmental disorder (e.g., Pervasive Developmental Disorder not otherwise specified, Autism, Asperger's Syndrome, Rett syndrome; and Childhood disintegrative disorder), a depressive disorder, a posttraumatic stress disorder (PTSD), a dissociative disorder, a Bipolar Disorder (including a Bipolar Disorder with Psychotic features), Impulse Control disorder not otherwise specified, an Attention Deficit Disorder (ADD), Schizoprenia, an Attention Deficit and Hyperactivity Disorder (ADHD), a Non-Verbal Learning Disorder, and Learning Disability not otherwise specified. Pervasive Developmental Disorder not otherwise specified, Autism, and Asperger's Syndrome are commonly called the autistic spectrum disorders and are conditions on the autistic spectrum. The posttraumatic stress disorder is a psychological disorder affecting individuals who have experienced or witnessed a profoundly traumatic event, including torture, murder, rape, wartime combat, or domestic violence. The torture includes a physical abuse and a mental abuse. In some embodiments, the person is person undiagnosed with a mental, physical or emotional disorder, who is experiencing stress or otherwise is in need of relaxation. For example, the subject may be undergoing a surgery and the cushion may be reducing the stress and/or producing relaxation during the surgical procedure. In another example, the person may have recently experience prolonged travel or workload, and the cushion produces relaxation.

Symptoms of the pervasive developmental disorder may include one or more of the following behavioral and communication problems: difficulty using and understanding language; difficulty relating to people, objects, and events; for example, lack of eye contact, pointing behavior, and lack of facial responses; unusual play with toys and other objects; difficulty with changes in routine or familiar surroundings; repetitive body movements or behavior patterns, such as hand flapping, hair twirling, foot tapping, or more complex movements; inability to cuddle or be comforted; and difficulty regulating behaviors and emotions, which may result in temper tantrums, anxiety, and aggression.

The term “stress” refers to a mental strain or a physical strain and is the body's way of reacting to a range of challenges. According to the stressful event, the way the body responds to stress is by sympathetic nervous system activation which results in the fight-or-flight response. Stress typically describes a negative condition or a positive condition that can have an impact on a person's mental and physical well-being. Thus, the term “stress” can refer to either mental stress or physical stress. Severe mental stress can be manifested by emotional dysregulation.

Physiological parameters used to assess stress level and reduction of stress include heart rate, body temperature, skin conductance, differences in finger temperature, frontalis muscle activity, electro cardiac activity, blood pressure, pupil expansion, muscle tension, respiratory rate and amplitude, brain wave, or any combination thereof. Alternatively, the stress level or reduction in stress level can be determined by measuring the level of stress hormones, such as cortisol and norepinephrine, in the blood. In another alternative, the person in need of therapy is asked to rate his/her level of stress or relaxation on a scale of 1 to 10, 1 being the least stressed and most relaxed, before and after the use of the cushion.

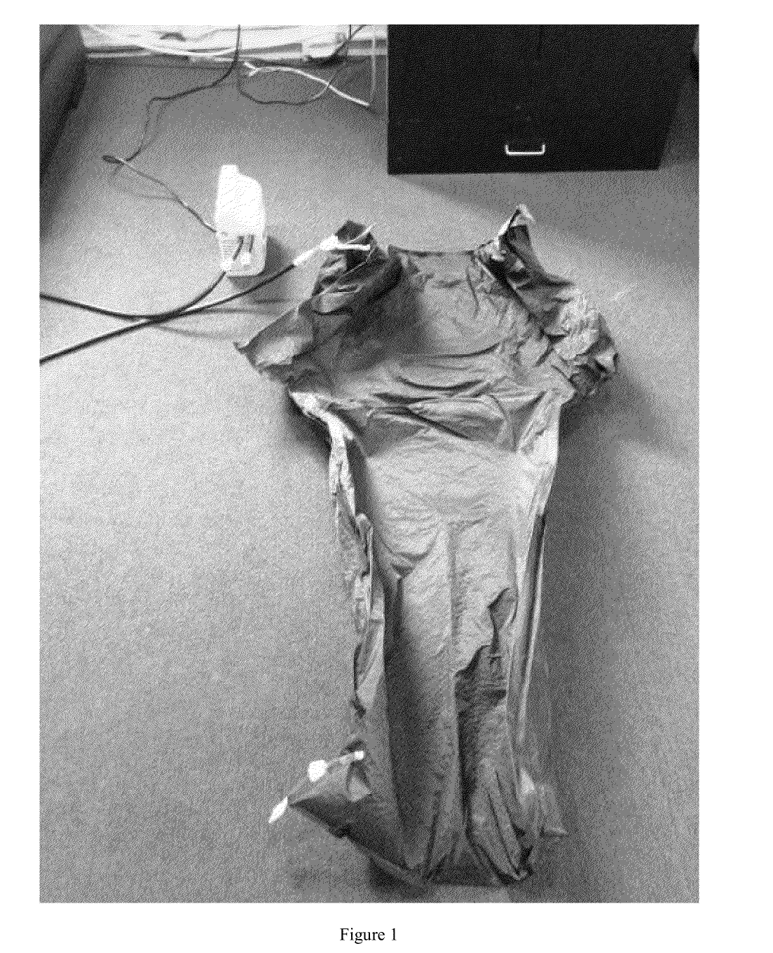

The cushion supports the body of the patient. In some embodiments, the calming cushion used in the methods is essentially a rectangular shaped, soft, and limp bean bag. Examples of the cushion include, but not limited to, the Bionix T-Vac cushion as shown in FIG. 1. A Bionix cushion was originally designed more than 20 years ago for the positioning and re-positioning of patients undergoing or receiving a course of external beam radiation therapy for the treatment of cancer and other diseases. The cushions are constructed from strong, vinyl coated nylon material that is filled with small polystyrene spheres to secure the patient in position. All cushion seams are double sealed to be airtight and fitted with a self-closing valve for ease of use. It also features an additional pinch clamp for more security. Once evacuated, the cushion molds to the contour of the patient's body (back and sides) and holds a rigid shape at least for the course of the radiation therapy treatment regimen or for an entire treatment cycle (6-8 weeks), but does not restrain the patient from sitting or getting up easily out of the cushion, even without the use of hand supports or assistance from others. Patients using the cushions are able to lie quiet and immobile for radiation therapy treatments because the form-fitting nature of the evacuated cushions supports their body comfortably and reproducibly. It is available in a variety of sizes and fills to meet treatment needs. Examples of the cushion also include other models include: the Bionix SecureVac Immobilization System, RT-7625/T-Vac Dual-Chamber SecureVac Cushion and RT-7600/Tri-Vac SecureVac Cushion, and other patient positioning devices made from PVC cushions filled with Polystyrene beads under CFR 892.5050.

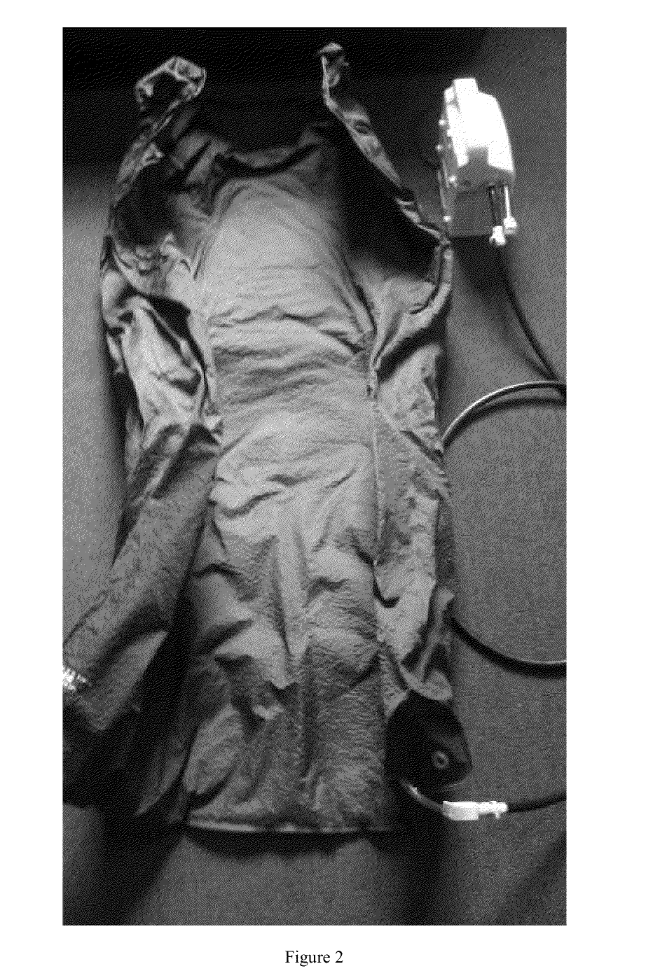

This cushion is suitable for placing in any place with a flat surface, including home, school, campsite, hospital, or mental health clinic. A person in need lies down on the cushion, positioned vertically in the middle of the cushion. The person may lie on their back or on their side. A vacuum pump is then connected to the nozzle. The cushion has a check valve operatively attached thereto. The vacuum pump has a pressure gauge for determining the pressure in the enveloped cushion. The shape of the cushion is ultimately formed by the withdrawal of air from the cushion while the individual is lying on it. Currently utilized pumps typically take 3 to 4 minutes to produce a desired shape comfortably enveloping the individual's body (see FIG. 2). Upon reaching the desired shape and pressure, the pump is then turned off and disconnected from the outlet. The cushion can stay attached to or be detached from a vacuum pump and retain the vacuum therein. The cushion has optionally built-in handles on two sides thereof that can be used to hold both sides up against the body of the person to be enveloped by the cushion during evacuation. The handles on both sides are positioned as such to ensure that they are simultaneously reachable by the hands of the person on the cushion. The enveloped cushion forms a snug fit against the person once evacuation is completed.

The following preferred embodiments as exemplified by the methods described herein are illustrative of the invention and are not intended to limit the invention as encompassed by the claims of this application. Although the inventive methods are described herein as applied to a student in a school setting, such a setting is merely for descriptive purposes and can be applied in a variety of settings to a variety of persons exhibiting mental stress with negative behavior, for example, dysregulated behavior.

Those exhibiting dysregulated behavior, adolescent students, as an example, are legion and those with whom the present method of therapy may be used are manifold. Such dysregulated behavior may be, for example, the result of brain injury that causes cognitive deficits; the result of early childhood sexual abuse; the results of acts of abuse and sexualized behaviors; the results of early childhood neglect and violence; the result of attachment disorders, the result of dissociative disorder; the result of inability to tolerate distress or regulate emotions; the result of lack of inhibition regarding anger, frustration, or disappointment; or the results of a range of neurological disorders including, e.g., Asperger's Syndrome and the Autistic spectrum, Pervasive Developmental Disorder not otherwise specified; mild to severe cognitive retardation. Examples of the dysregulated behavior include a range of acting out behaviors, including verbal and physically assaultive behaviors.

It is found that the use of this cushion has a calming effect with individuals exhibiting dysregulated behavior particularly in a setting with administrative policy that prohibits normative physical contact, i.e. arms around, a pat on the back, or hugs, policy that is at the same time necessary for maintaining healthy personal boundaries for this population. The cushion is a simple design, easily portable, cost effective, easily stored, and may help to offset the kinds of acting out incidents of this population. Moreover, because the individual is provided with a feeling of being held simulating the secure feeling a child feels when held by a caring adult, the cushion helps to create a more secure sense of boundaries with that individual who does not experience healthy personal boundaries.

The process for implementing the method may begin with consent, including consent by parents or guardians of the recipient student. It may be important for the students to know that the cushion was approved by their parents.

Initial Introduction: To begin, each student is interviewed using a questionnaire with questions determining their awareness of their triggers, and strategies to maintain or regain a state of calm. Before the interview, opportunities to informally interact with these students may be chosen so that the administrator of the method would not only be familiar to them, but also be seen as a friendly, supportive presence. Regarding cooperation, it is crucial that a therapeutic alliance, i.e. a trusting relationship first be established. If necessary for cooperation, a program-token reward may be offered. However, not every student cares about a reward.

In the interview, another therapist/administrator may take notes. Each student is asked about their willingness to try something new that might help them to manage better their hard-to-manage emotions and behaviors. It is important to make it clear that it is entirely the student's choice without any negative consequence should the student refuse.

How a session is initiated may vary with each individual, for example, where they are, what they are doing, the time of day, whether they are likely to be hungry, or if they are on the way to an anticipated activity.

Initiation of sessions is preferably by invitation, for example, one may ask the student, “Is it a good time for you to use the cushion?”. Alternatively, one may not ask whether the student wants to use the cushion, but rather where he should go to use it, i.e. which room among available rooms. If the student is involved in another activity, e.g. drawing or on the computer, it may be necessary to briefly speak with them to determine their need for transition time: whether they'd like a few more minutes or whether they'd like to schedule another time. Such an option only occurs when there is not an overt behavioral issue.

How the cushion works is then physically demonstrated for each individual. Even though the cushion has the effect of synthesizing a hug-like feeling, reference to a “hug” is not made, knowing the background of the students where associations with “hugs” could be detrimental or overly stimulating. The term “hug” is not to be used, rather, when asking for feedback, the administrator asks neutral questions such as ‘how does the cushion feel, what do you notice’, not imposing descriptive words.

For every occasion of use, an Information Sheet with basic data is typically kept. In the minutes of preparing the cushion there is minimal talking by the therapist. Privacy is essential. The student is shown the preparation of the cushion, evening out bumps, for example. Students may want to help with the smoothing process, which can be a problem if they have rigorous, aggressive movements. Such help should be discouraged, although a student can help with covering the cushion with their personal sheet, if they want to. If a pillow is preferred, it is also covered with the sheet.

The cushion, placed flat on the floor, is situated to avoid strong sunlight and is placed close enough to an electrical outlet. The cushion is positioned for the student to lie down from head to foot with the corner that has an inlet nozzle for the pump closest to the student's feet. The student chooses a preferred position, whether on their back or side, and lies down on the cushion, positioned vertically in the middle of the cushion. A vacuum pump is then connected to the nozzle. The pump is plugged in but not yet turned on.

The student is typically told that the noise from the pump sounds something like a hair dryer. The student is asked where they want to place their hands for comfort; on their stomach, at their side, or over their head. If the position of their hands will keep the sides of the cushion at a distance, thereby minimizing optimal pressure, another position is suggested for their arms and hands. The student is asked to rate their level of calm before starting, on a scale of 1 to 10, 1 being the calmest. Although the students' ratings do not always match what their body language shows, there is benefit in having them rate their level of calm.

Before turning on the pump, the student is asked whether they are comfortable and ready. The exact time for timing the duration of use is noted, using an Information sheet. Often, 15 minutes is sufficient to achieve the desired calming effect.

The pump is turned on to a vacuum function while the sides of the cushion are held against the side of the patient. Another staff member may be employed so that the therapist and the assistant are positioned on opposite sides of the cushion each holding the cushion's side against the student's side thereby creating pressure against the student's body. This maneuver can also be administered by one person holding up the two sides of the cushion. The student is asked when the “fit” of the cushion feels best.

The change from a soft, limp bean bag to a safe supportive form is what begins to induce a feeling of calm. As used herein, “safe” may be defined as any supportive pressure that is not harmful to the patient, with no non-transient negative physiological effect on the body. “Safe” pressure may be one that does not substantially constrain or substantially restrain the patient's body such that the patient can move out of the cushion at will. “Safe” pressure may further include pressure sufficient to provide a positive feeling of being held in a comfortable secure hold. Currently utilized pumps typically take 3 to 4 minutes to produce the desired safe pressure. The pump is then turned off and disconnected from the outlet.

Once the student is lying in the cushion, they are given the option to lie quietly, talk, listen to music or do a breathing exercise. The student is not left alone. If they prefer to lie quietly, the therapist sits at a distance noting the student's body language and any remarks they make.

It may sometimes be necessary to gently engage the student in talking about their day, or to talk about a particular incident. The details of these exchanges, are, in some cases, significant for how easily the student could report on a situation they would otherwise avoid speaking about.

Typical treatment times to achieve a calming effect are in the order of fifteen minutes of lying in the cushion. If a student gets up sooner, the therapist asks if they want to stay a little longer. If fifteen minutes passes and the student looks fully relaxed, the student is asked if they are ready to get up. The student is asked how lying in the cushion affected them and to rate their level of calm compared to how they rated their level of calm as they did before they used the cushion. The student is accompanied to a storage area in which the cushion, the pump, and the sheet may be stored. The student is then walked back to wherever they are scheduled to be and praised for how well they did.

The cushion is basically a rectangular shaped bean bag and is a novel therapeutic application of a product that was originally devised and is currently used for radiation treatment. The cushion is manufactured by Bionix as, “SecureVac Immobilization System”, found, for example, at: www.bionixrt.com/RT_Pages/SecureVac.html. Other models include: RT-7625/T-Vac Dual-Chamber SecureVac Cushion and RT-7600/Tri-Vac SecureVac Cushion. Bionix's description is, “ . . . durable, accurate and cost-effective . . . reusable and airtight filled with small polystyrene spheres to immobilize the student . . . made of nylon material . . . stronger to prevent punctures and leaks; adaptable to industry standard pumps”. It is available in a variety of sizes and fills to meet treatment needs. The pump used herein is Bionix's RT-7101/SecureVac Pump.

While this description suggests immobilization, in fact, the cushion itself is not a restraining device. In radiation treatment, it can achieve precision. The patients can easily move in and out of the cushion, which is formed to fit their torso or full body length. The individual form is produced by the vacuum pump. The present method is consistent with there being no constraints, or restraining feature. No side effects or risks are involved with its use.

The shape of the cushion is ultimately formed by the withdrawal of air from the cushion while the individual is lying on it. Because the cushion is reusable, each individual typically has their own sheet to lie on over the cushion. A pillow may optionally be used if desired. Each cushion, starting in the form of a flat bean bag, is formed into the shape of the individual's torso while the individual is lying on the cushion. This process, itself, allows the individual to find relaxing.

The cushion may be used, in some cases, when the individual is in a fairly controlled state. In some cases, it may be used to prevent escalation of an agitated state. After they have been exposed to the present method of therapy, individuals may request use of the cushion themselves.

Cushions may be maintained in the individual's form from week to week, as long as six to eight weeks (i.e., may be “previously formed” prior to use in a particular session). Alternatively, they may be reformed for each occasion of use. Each use has its associated advantage. For the individual who has no tolerance to wait, who is ambivalent about using the cushion, and who is motivated by a token reward, having the already formed cushion is a great advantage. Forming the cushion for each occasion of use has additional advantage of the individual experiencing an increasing sense of pressure with each use where the individual informs the therapist when it is most comfortable.

In some circumstances, at the onset of a negative behavior, if an individual doesn't make the choice to take a self-time-out, someone on the staff of the program administering the present method will direct the individual to a Time Out space to calm down. This method has many steps depending on the extent of the negative behavior. If the negative behavior escalates, as necessary, staff will put hands on the individual i.e. two staff will lock arms on either side of the individual, in an Escort. If the individual's behavior continues to escalate, staff will safely take the individual down into a restraint. A restraint lasts as long as necessary until the individual regains control and is calm enough to rejoin the community.

It is to be understood that the following examples of the present invention are not intended to restrict the present invention since many more modifications may be made within the scope of the claims without departing from the spirit thereof.

### Example 1

A female volunteer, who is healthy and under no particular emotional stress, used the cushion for 15 minutes and described her feelings as follows:
1) notice the holding feeling;
2) surprised by the relaxing feeling of every muscle, feels calmer though wasn't stressed to begin with;
3) relaxing, compression feels nice to push out and have cushion push back; while lying in it was seeking pressure points, was calming; suggests using as protocol for new admissions;
4) feels very cozy; the pressure feels good; love the pressure, makes me feel very secure, more contained than lying on a bed; I search for this feeling when having sensory overload; it's [the cushion] is enough to override the feeling of overload; I use a weighted blanket; this feels better, from the lower part of my body to the top; and
5) pressure feels good; better able to focus on my breathing, less distracted; feels good on my back; feels like a cocoon, protected; calming; puts me more in my body than in my head, more grounded; would welcome a weighted blanket on my chest and feet; and if it had a warming element.

### Example 2

An example of the information and questions included in a typical consent form may be: name of parent, name of student and a description and duration of the treatment method. Such a treatment may be described as: “The Intervention will provide a comfort cushion for sensory soothing in conjunction with routine behavior management and self-management procedures already in place. The purpose of the Intervention is to determine, if by using the cushion, either in moments of distress or at a scheduled time, that the use of the cushion will sustain the student's emotional regulation and decrease the overall number of behavioral incidents. The use of the cushion by the student is entirely voluntary. A staff member will be present at all times when the cushion is in use should the student experience distress. Consent can be withdrawn at any time.” The cushion may be described as: “The cushion is made of thick durable nylon. It will be shaped for each student's torso, from the back, or from the front, from neck to waist, from waist to leg length, depending on the height of the individual, to lie in easily, with comfort and without any restraint. The cushion will be formed with the student's participation. The student may remove him/herself from the cushion at any time.”

An example of the preliminary questions that may be asked of the student to assess their awareness before engaging as a participant, may include, for example, “What triggers you, gets you frustrated and angry, and feeling out of control? Name as many as you can. When you are triggered, what is the most helpful way you can get calm again? Say whatever you can. When you feel frustrated, disappointed, or angry, or on the positive side, excited or happy, how do you manage to stay in control? Say whatever comes to mind. What is the hardest part of your day? What is the best part of your day? How do you feel if someone accidentally touches you or bumps against you? Is there a feeling this triggers in you? Would you say that you know how to calm yourself when you start to feel overwhelmed by feelings or thoughts? Would you be willing to try something new that might help you feel more comfortable in yourself and calmer at times when you start to lose it? This would be using a kind of comfort cushion.

### Individual Data from Experimental Use

Data from a pilot intervention using the method of the present invention by the inventor is as follows. (Names not used. Individuals are referred to as Student A, B, C, D, E; genders not designated: 2 females, 3 males).

Counting 23 weeks total from the beginning of the Intervention in February to week of Jul. 23, 2012, noting that the therapist was away almost 2 weeks of that time. Student B, the exception, used the cushion over an 8 week period. Student E, who started after the others, used the cushion over a 16 week period.

Quantitative Data are Selective Remarks by students and Selective Observations:

Student B:
Diagnosis: Mild Retardation, ADHD, Bipolar Disorder
Frequency per wk.: over 16 week period—one time per week for eight weeks (8 wk/1X); two times per week for two weeks (2 wk/2X); and three times per week for one week (1 wk/3X).
Time of day: 3:30 pm
Location: in dorm room
Total minutes: 141 min.
Average Duration: 9.5 min
Total number of uses: 15
Student: You interrupted my video game for this? I don't see how it can work.
Inventor: Asked if Student B wanted me to stay or wait at the doorway of the room. Wanted me to stay; happily accepted a token reward after use.
Student: Complained about a new peer; complained about being in this program; refused to lie in the already formed cushion; agreed to use it for 8 minutes.
Student: Let's get this over with. How much longer. Video games are my stress relievers.
Inventor: Took several requests to have Student B put the video game on pause; Paused, then got into the Cushion.
Student: I'm lying in it, using it for 2 minutes to help me relieve some of my stress. Used it for 5.
Student: Took initiative to stop by inventor's office door to inform her of the week's schedule; wanted to tell her B is free tomorrow [for the cushion].
In subsequent sessions, became more talkative. B said B only used the cushion for the reward. Student B used the cushion the least amount of time; is the only student who did not show a difference regarding behavioral incidents.

Student C:
Diagnosis: Traumatic Brain Injury, Mood Disorder, ADHD, Borderline Intellectual functioning.
Frequency per wk.: 7 wk/1X; 2 wk/2X; and 1 wk/3X
Time of day: 4 pm
Location: in dorm room or community room
Total minutes: 139
Average Duration: 9.9 min
Total number of uses: 14
using a ready-made cushion, custom made.
Student: It's good. Asked if Student C could take the cushion home. Told mother C loves the cushion; it makes C feel very relaxed, that C likes how it feels around C's [body].
Inventor: Student C has high energy, is easily triggered by interactions on the bus at the end of the day.
Student: Agitated by an incident earlier in the day. Accepted the cushion immediately. Asked if C could take the cushion home. Was more focused while lying in the cushion than usual, able to have a conversation.
Student: I did the breathing you showed me.
Inventor: After use, observed C smiling, enthusiastically coming to tell me C is on the Level that allows for going off grounds shopping.
Student: (Hearing loud noise from a peer) Stayed atypically calm and quiet in the cushion; given the option, requested a cushion that has to be formed.

Student A:
Diagnosis: ADHD, PTSD, Bipolar Disorder with Psychotic features, Mild Retardation
Frequency per week: −8 wk/1X; 6 wk/2X; 1 wk/3X; and 1 wk/5X.
Time of day: 2 pm
Location: Community room
Total minutes: 387 min.
Average Duration: 13.3 min.
Total number of uses: 28
Student: I feel relaxed. [fully cooperative]. It felt snug. It felt calm. Described feeling calmer after using it, having been sent to Time Out earlier where A was standing on the bench screaming Time Outs are for babies.
Inventor: Accepting limits better where limits are a big challenge for Student A.
Student: Complaining of body aches.
Inventor: Directing A while A is lying in the cushion to do breathing and focus on the part of the body that is achy. For each set of breaths, A reports feeling better [not clear that the complaints were founded]. Body language calmer after cushion.

Student E:
Diagnosis: Asperger's Syndrome, ADD, Anxiety Disorder
Frequency per week: 5 wk/1X; 5 wk/2X; and 2 wk/3X
Time: 12 Noon
Location: Community room
Total minutes: 347 min.
Average Duration: 15.2 min.
Total number of uses: 21
Student: First use, mentioned Temple Grandin's Squeeze machine. She said she hopes the cushion will help her feel less anxious, less tense. [Listens to CD's with eyes closed].
Inventor: lying looking atypically relaxed.
Inventor: via reporting from staff: Student E said she enjoys the calm, soothing feeling she receives from the cushion. Admits to having a restless mind. The cushion feels like a big hug.

Student D:
Diagnosis: Non-Verbal Learning Disorder; Congenital Nystagmus, Generalized Anxiety Disorder,
Frequency per week/Duration: 9 wk/1X and 3 wk/2X
Time: 11:30 am to 3:30 pm
Location: dorm room or Community room
Total minutes: 195 min.
Average Duration: 13 min.
Total number of uses: 15
Student: making provocative remarks; admitted to feeling hyper. [The cushion] feels good. Making loud singing tones; singing a favorite song. Became completely relaxed, talked minimally, when talking was completely appropriate, a chronic challenge for Student D.

### Specific Data Sums for the Intervention

It's important to note that the sums below should be taken into account in relation to the qualitative data and that the sums do not reflect the situation in which an Incident occurred. The sums that indicate a student taking initiative for a Self Time Out are the most notable, in the cases of Student D, A, and B. Student E taking fewer Self Time Outs is a positive indicator for her.

The nomenclature is as follows:
Ed: School Day
Res: After school, residential time
T.O.: Time Out initiated by staff
Self: A Time Out initiated by student. Taking Self Time-Outs is a goal of self-management.
Escort: Staff walk on either side of a student with their arms locked under the student's elbows
Restraint: staff take a student down due to the student's assaultive behavior

Student D:

| | Before | After |
|---|---|---|
| Ed T.O. | 43 | 61 |
| Res T.O. | 14 | 18 |
| Ed Selfs | 2 | 16 |
| Ed Escorts | 2 | 3 |
| Res Escorts | 5 | 0 |
| Ed Restraints | 1 | 3 |
| Res Restraints | 2 | 0 |

Student A:

| | Before | After |
|---|---|---|
| Ed T.O. | 49 | 43 |
| Res T.O. | 81 | 57 |
| Ed Selfs | 21 | 20 |
| Ed Escorts | 1 | 2 |
| Res Escorts | 7 | 7 |
| Ed Restraints | 3 | 1 |
| Res Restraints | 3 | 6 |

Student C:

| | | After (is only a |
|---|---|---|
| | Before | residential student) |
| Res T.O. | 37 | 0 |
| Res Escorts | 3 | 0 |
| Res Restraints | 2 | 0 |

Student E: does not have overt behavioral issues, but experiences intense social anxiety.

| | Before | After |
|---|---|---|
| Ed T.O. | 2 | 0 |
| Ed Selfs | 10 | 6 |
| Ed Escort | 0 | 0 |
| Ed Restraint | 0 | 0 |

### Summary of Additional Results for the Calming Cushion

Of the five students currently involved in this Pilot Intervention, here are some results. These results will have a greater impact when presented in the context of each student's profile and life situation.

Student C: Before—frequent restraints; After—No restraints since starting use of the cushion; Has taken more Self Time Outs. Has had fewer staff Time Outs. In Student C's own words says there is a calmer feeling as a result of using the cushion. It should be noted that Student C typically exhibits inattention and hyper levels of energy. In sessions using the cushion, Student C showed an unusual capacity to stay focused and make eye contact while talking to the therapist.

Student A: Before—frequent restraints; After—Has had fewer Escorts and Restraints; Has same number of Staff Time Outs, but is taking more Self Time Outs during the school day; Has requested the cushion when feeling frustrated or angry.

Student E: has to manage intense anxiety. No staff Time Outs since starting the cushion.

Student D: Before—Had 5 Staff Time Outs a day; After—fewer Staff Time Outs, is taking more Self Time Outs than before.

Student B: Before and After—Restraints are the same; Student B used the cushion the least amount of time compared to the other students.

It is the safe pressure, and the secure, comforting feeling of being held that might be internalized, and in time may provide a sense of being more connected to one's body and to experience a feeling of well-being exercising more control of one's behavior. Expected results include a decrease in incidents related to acting out behaviors and need for restraints. Further, this treatment method has application for other populations and programs, for facilities or institutions serving those with cognitive disabilities, psychiatric disorders, or those on the autistic spectrum. The use of the cushion could be applied to those who have experienced trauma, such as domestic violence, sexual assault, or the result of tenor. It could be applied to detox programs.

The method, as mentioned, could be applied to those on the Autistic spectrum, as a possible “hugging” cushion. Other possible applications may include populations of those suffering from back pain, babies with colic, frail elders, and those having difficulties arising during pregnancy. Addressing loneliness should be a consideration in researching those with debilitating depression.

Although the particular embodiments shown and described above will prove to be useful in many applications in the therapeutic art to which the present invention pertains, further modifications of the present invention will occur to persons skilled in the art. All such modifications are deemed to be within the scope and spirit of the present invention as defined by the appended claims.

1. A method for reducing stress or promoting relaxation in a person in need thereof, comprising:
(a) positioning a person in need upon a deflatable cushion, wherein the deflatable cushion extends at least the length of the person's torso;
(b) eliminating a sufficient amount of air from the cushion to form an enveloping cushion that at least partially envelops the person; and
(c) retaining the person in the enveloping cushion for a sufficient time for reducing the stress or producing relaxation in the person.

2. The method of claim 1, further comprising holding the cushion sides against the person during step (b).

3. The method of claim 2, wherein the enveloped cushion forms a snug fit against the person at the end of step (b).

4. The method of claim 1, further comprising retaining the cushion in the enveloped state for use at another time.

5. A method for reducing stress or promoting relaxation in a person in need thereof, comprising:
(a) positioning a person in need upon a cushion that is preformed to have a snug fit against the person, wherein the cushion extends at least the length of the person's torso; and
(b) retaining the person in the enveloped cushion for a sufficient time for reducing the stress or producing relaxation in the person.

6. The method of claim 1, wherein the method is administered to the person with or without assistance from another person.

7. The method of claim 1, further comprising speaking to the person or providing therapy to the person when being enveloped in the cushion.

8. The method of claim 7, further comprising obtaining verbal feedback from the person regarding the fit of the cushion.

9. The method of claim 1, wherein the cushion has at least one handle on each side, which is readily reachable by the hands of the person positioned on the cushion.

10. The method of claim 1, wherein the person suffers from at least one condition selected from the group consisting of autism, a severe traumatic brain injury, a posttraumatic stress disorder, neglect, and abandonment.

11. The method of claim 10, wherein the person suffers from autism.

12. The method of claim 10, wherein the person suffers from severe traumatic brain injury.

13. The method of claim 10, wherein the person suffers from a posttraumatic stress disorder, wherein the posttraumatic stress disorder is a psychological disorder affecting individuals who have experienced or witnessed a profoundly traumatic event.

14. The method of claim 13, wherein the profoundly traumatic event is torture, murder, rape, or wartime combat.

15. The method of claim 14, wherein the torture is a physical abuse or a mental abuse.

16. The method of claim 10, wherein the person suffers from neglect or abandonment.

17. The method of claim 1, wherein the method is performed on a flat surface at home, school, campsite, hospital, or mental health clinic.

18. The method of claim 1, wherein stress is reduced in the person such that the frequency of time outs required by the person is significantly reduced.

19. The method of claim 1, wherein stress is reduced in the person such that the frequency of restraints required for the person is significantly reduced.

20. The method of claim 1, wherein stress is reduced in the person such that the frequency of escorts required for the person is significantly reduced.

21. The method of claim 1, wherein stress is reduced in the person such that the person can participate in normal daily activities without provocative or inappropriate behavior caused by stress.
